(19) United States
(12) Patent Application Publication
(10) Pub. No.: US 2023/0169670 A1
(43) Pub. Date: Jun. 1, 2023

(54) DEPTH ESTIMATION METHOD, DEPTH ESTIMATION DEVICE AND DEPTH ESTIMATION PROGRAM

(71) Applicant: NIPPON TELEGRAPH AND TELEPHONE CORPORATION, Tokyo (JP)

(72) Inventors: Go IRIE, Musashino-shi, Tokyo (JP); Daiki IKAMI, Musashino-shi, Tokyo (JP); Takahito KAWANISHI, Musashino-shi, Tokyo (JP); Kunio KASHINO, Musashino-shi, Tokyo (JP)

(73) Assignee: NIPPON TELEGRAPH AND TELEPHONE CORPORATION, Tokyo (JP)

(21) Appl. No.: 17/921,282

(22) PCT Filed: Apr. 30, 2020
(86) PCT No.: PCT/JP2020/018315

§ 371 Date: Oct. 25, 2022

(51) Int. Cl. G06T 7/50

(52) U.S. Cl. CPC G06T 7/50; G06T 2207/20084; G06T 2207/20081

(57) ABSTRACT

A depth estimation method using a depth estimator trained to output a depth map of a depth provided to each pixel of an input image, in which: the depth estimator includes a pair of a first convolutional layer and a second convolutional layer coupled to each other and configured to, when having received, as input, a tensor obtained by applying predetermined conversion to an input image, apply a two-dimensional convolution operation to the tensor and output the tensor to which the two-dimensional convolution operation is applied; the first convolutional layer is a convolutional layer including a first kernel of a shape having lengths in a first direction and a second direction, the first direction being one of a vertical direction and a horizontal direction, the second direction being different from the first direction, the length in the second direction being longer than the length in the first direction; and the second convolutional layer is a convolutional layer including a second kernel of a shape having lengths in the first and second directions, the length in the first direction being longer than the length in the second direction.

### TECHNICAL FIELD

The present invention relates to a depth estimation method, a depth estimation device, and a depth estimation program.

### BACKGROUND ART

Remarkable progress has been made in artificial intelligence (AI) technologies. One of applications of image recognition technologies by artificial intelligence that have recently drawn attention is utilization as an “eye” of a robot. In manufacturing industries, factory automation by a robot having a depth estimation function has been introduced since a long time ago. Spread to fields, such as conveyance and stock management, carriage, and transport in retail and logistics, in which higher recognition is required is expected along with development of robot AI technologies.

A typical image recognition technology is a technology of predicting the name (hereinafter referred to as “label”) of an object captured in an image. For example, outputting of a label “apple” is desirable operation of a depth estimation technology when an image in which an apple is captured is input. Alternatively, the desirable operation is allocation of a label “apple” to a region in which an apple appears in the image, in other words, a set of pixels.

In an image recognition technology applied to a robot as described above, such label outputting is often insufficient. For example, consider a robot utilization case at a retailer in which a product on a goods shelf is grasped and transported to a product shelf at another place. To accomplish such a task, a robot needs be able to execute processes (1) to (4) described below.

(1): Specification of a transport target product from among various products on a goods shelf.
(2): Grasping of the target product.
(3): Movement and transport of the target product to a destination product shelf.
(4): Disposition in desirable arrangement.

In an image recognition technology, it is needed to be able to recognize a goods shelf, a product, and a product shelf and to be able to accurately recognize three-dimensional shapes such as the structure of the goods shelf and the posture (position, angle, and size) of the object. The typical image recognition technology as described above does not have such a shape estimation function and thus needs another technology for shape estimation.

A shape can be known by obtaining width, height, and depth. It is possible to visually recognize the width and height from an image, but not information of the depth. To obtain information of the depth, some efforts are needed, such as use of two or more images captured from another viewpoint like a method described in Patent Literature 1, for example, or use of a stereo camera or the like.

However, it is not always possible to use such a device and an image capturing method. Thus, it is preferable that a method capable of obtaining depth information only from one image can be used. Depth estimation technologies that can estimate depth information of an image have been developed to meet such a requirement.

For example, a method using a deep neural network is known. This method is a method of training a deep neural network to receive an image as input and output depth information of the image. Neural networks of various structures have been disclosed to enable estimation of highly accurate depth information (refer to Non Patent Literatures 1 to 3, for example).

A large number of existing technologies employ a structure in which a low-resolution feature map is extracted by using any typical network and then converted into a high resolution through a network (hereinafter referred to as “upsampling network”) that upsamples the low-resolution feature map, thereby restoring depth information. For example, Non Patent Literatures 1 and 2 disclose a structure in which a feature map extracted by a network based on a deep residual network (ResNet) disclosed in Non Patent Literature 3 is converted into depth information by using an upsampling network constituted by a plurality of upsampling blocks called UpProjection. In UpProjection, the resolution of an input feature map is doubled, and then the feature map is subjected to a convolutional layer including a small square convolutional kernel of 3×3, 5×5, or the like, thereby restoring depth information.

Some methods for contriving the entire network have been disclosed (refer to Non Patent Literature 4, for example). Non Patent Literature 4 discloses a structure in which an input image is subjected to a plurality of networks having different output resolutions to accurately estimate the structure of depth information, ranging from its rough structure to a detail part.

### CITATION LIST

### Patent Literature

Patent Literature 1: Japanese Patent Laid-open No. 2017-112419

### Non Patent Literature

Non Patent Literature 1: Iro Laina, Christian Rupprecht, Vasileios Belagianis, Federico Tombari, and Nassir Navab, “Deeper Depth Prediction with Fully Convolutional Residual Networks”, In Proc. International Conference on 3D Vision (3DV), pp. 239-248, 2016.
Non Patent Literature 2: Fangchang Ma and Sertac Karaman, “Sparse-to-Dense: Depth Prediction from Sparse Depth Samples and a Single Image”, In Proc. International Conference on Robotics and Automation (ICRA), 2018.
Non Patent Literature 3: Kaiming He, Xiangyu Zhang, Shaoqing Ren, and Jian Sun, “Deep Residual Learning for Image Recognition”, In Proc. Conference on Computer Vision and Pattern Recognition (CVPR), 2016.
Non Patent Literature 4: David Eigen, Christian Puhrsch, and Rob Fergus, “Depth Map Prediction from a Single Image using a Multi-Scale Deep Learning”, In Proc. Advances in Neural Information Processing Systems (NIPS), 2014.
Non Patent Literature 5: Tom van Dijk and Guido de Croon, “How Do Neural Networks See Depth in Single Images”, In Proc. Int. Conference on Computer Vision (ICCV), 2019.

### SUMMARY OF THE INVENTION

### Technical Problem

Existing inventions disclose various network structures of a configuration in which convolutional layers including small square convolutional kernels are combined. Use of small square kernels implicitly assumes that the depth of a pixel of an image can be approximately estimated based on pixels closely around the pixel.

However, typically, a normally captured image is often obtained through image capturing in parallel to the ground. In this case, horizontally arranged pixels presumably have the same distance, in other words, the same depth without any screening object in a space as an image capturing target. Furthermore, according to Non Patent Literature 5, an analysis result indicates that, when there is a screening object, a neural network for estimating depth information estimates depth information based on the position of a pixel in the vertical direction. Accordingly, the existing method cannot refer to a pixel thought to provide information that is useful for depth information estimation, and as a result, cannot obtain high estimation accuracy, which has been a problem.

The present invention is intended to solve the above-described problem and provide a technology capable of highly accurately estimating depth.

### Means for Solving the Problem

An aspect of the present invention is a depth estimation method using a depth estimator trained to output a depth map of a depth provided to each pixel of an input image, in which: the depth estimator includes a pair of a first convolutional layer and a second convolutional layer coupled to each other and configured to, when having received, as input, a feature map obtained by applying predetermined conversion to the input image, apply a two-dimensional convolution operation to the feature map and output the feature map to which the two-dimensional convolution operation is applied; the first convolutional layer is a convolutional layer including a first kernel of a shape having a length in a first direction as one of a vertical direction and a horizontal direction and a length in a second direction different from the first direction, the length in the second direction being longer than the length in the first direction; and the second convolutional layer is a convolutional layer including a second kernel of a shape having lengths in the first and second directions, the length in the first direction being longer than the length in the second direction.

Another aspect of the present invention is a depth estimation device including a depth estimator trained to output a depth map of a depth provided to each pixel of an input image, in which: the depth estimator includes a pair of a first convolutional layer and a second convolutional layer coupled to each other and configured to, when having received, as input, a feature map obtained by applying predetermined conversion to the input image, apply a two-dimensional convolution operation to the feature map and output the feature map to which the two-dimensional convolution operation is applied; the first convolutional layer is a convolutional layer including a first kernel of a shape having a length in a first direction as one of a vertical direction and a horizontal direction and a length in a second direction different from the first direction, the length in the second direction being longer than the length in the first direction; and the second convolutional layer is a convolutional layer including a second kernel of a shape having lengths in the first and second directions, the length in the first direction being longer than the length in the second direction.

Another aspect of the present invention is a depth estimation program configured to cause a computer to execute the above-described depth estimation method.

### Effects of the Invention

According to the present invention, it is possible to highly accurately estimate depth.

### BRIEF DESCRIPTION OF DRAWINGS

FIG. 1 is a block diagram illustrating a specific example of a functional configuration of a depth estimation device in the present embodiment.

FIG. 2 is a diagram illustrating an exemplary configuration of a depth estimator in the present embodiment.

FIG. 3 is a diagram illustrating an exemplary configuration of an upsampling block in the present embodiment.

FIG. 4 is a diagram illustrating a range of pixels referred to by two convolutional kernels of a first branch unit when the upsampling block has the configuration illustrated in FIG. 3.

FIG. 5 is a diagram illustrating the configuration of an upsampling block disclosed in Non Patent Literature 2.

FIG. 6 is a diagram illustrating a range of pixels referred to by the two convolutional kernels of the first branch unit when the upsampling block has the configuration illustrated in FIG. 5.

FIG. 7 is a flowchart illustrating the process of training processing performed by the depth estimation device in the present embodiment.

FIG. 8 is a flowchart illustrating the process of estimation processing performed by the depth estimation device in the present embodiment.

FIG. 9 is a diagram illustrating an example of a first modified configuration of the upsampling block.

FIG. 10 is a diagram illustrating an example of a second modified configuration of the upsampling block.

FIG. 11 is a diagram illustrating experimental results obtained by performing depth estimation by using depth estimation methods established by a conventional technology and a technology of the present invention.

### DESCRIPTION OF EMBODIMENTS

An embodiment of the present invention will be described below with reference to the accompanying drawings.

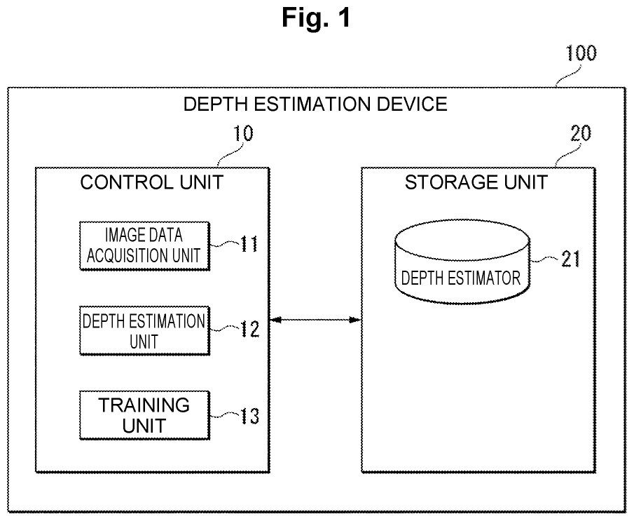

FIG. 1 is a block diagram illustrating a specific example of a functional configuration of a depth estimation device 100 in the present embodiment.

The depth estimation device 100 estimates depth information of a space captured in an input image. The depth estimation device 100 includes a control unit 10 and a storage unit 20.

The control unit 10 controls the entire depth estimation device 100. The control unit 10 is configured by using a processor such as a central processing unit (CPU), and a memory. The control unit 10 implements functions of an image data acquisition unit 11, a depth estimation unit 12, and a training unit 13 by executing a computer program.

Some or all functional components of the image data acquisition unit 11, the depth estimation unit 12, and the training unit 13 may be implemented by a hardware component such as an application specific integrated circuit (ASIC), a programmable logic device (PLD), or a FPGA or may be implemented by software and hardware components in cooperation. The computer program may be recorded in a computer-readable recording medium. The computer-readable recording medium is a non-transitory storage medium, for example, a portable medium such as a flexible disk, a magneto optical disc, a ROM, or a CD-ROM, or a storage device such as a hard disk built in a computer system. The computer program may be transmitted through an electric communication line.

Some functions of the image data acquisition unit 11, the depth estimation unit 12, and the training unit 13 do not necessarily need to be implemented on the depth estimation device 100 in advance but may be implemented through installation of an additional application program on the depth estimation device 100.

The image data acquisition unit 11 acquires image data. For example, the image data acquisition unit 11 acquires training image data used for training processing and image data used for estimation processing. The image data acquisition unit 11 may acquire image data from outside or image data stored inside. The training image data is constituted by one or more pairs of an input image and a correct-answer depth map for the input image.

The depth estimation unit 12 inputs image data acquired by the image data acquisition unit 11 into a depth estimator stored in the storage unit 20, thereby generating a depth map indicating depth information of a space captured in an input image. In this processing, the depth estimation unit 12 reads parameters of the depth estimator from the storage unit 20. The parameters of the depth estimator need to be determined at least once by training and recorded in the storage unit 20 before estimation processing described in the present embodiment is executed. The depth estimation unit 12 outputs the depth map obtained by the depth estimator as a depth estimation result.

The depth map is a map storing, for each pixel value of the input image, information of the distance in the depth direction from a measurement device (for example, camera), which is a depth at a place where the measurement target space is positioned. The depth map has a width and a height equal to those of the input image. The unit of the distance may be optional and is, for example, meter or millimeter.

The training unit 13 updates and trains the parameters of the depth estimator based on the training image data acquired by the image data acquisition unit 11. Specifically, the training unit 13 updates and trains the parameters of the depth estimator based on the depth map, which is obtained based on each input image as the training image data, and the corresponding correct-answer depth map so that the depth map becomes close to the correct-answer depth map. The training unit 13 records the depth estimator having the updated parameters in the storage unit 20.

A depth estimator 21 is stored in the storage unit 20. The depth estimator 21 stored in the storage unit 20 is associated with latest information of parameters. The depth estimator 21 is trained to output, when having received an image as input, a depth map storing depth information of a space captured in the input image.

The depth estimator 21 in the present embodiment has a configuration in which a first convolutional layer including a kernel that is long in any one of the vertical and horizontal directions is coupled to a second convolutional layer including a kernel that is long in a direction different from the one direction of the first convolutional layer. More specifically, the depth estimator 21 has a configuration in which the first convolutional layer among sequential convolutional layers includes a kernel having a longer length in any one of the vertical and horizontal directions than the other length and the second convolutional layer has the shape of the transpose of the first convolutional layer. For example, when the first convolutional layer includes a kernel that is long in the vertical direction, the second convolutional layer includes a kernel that is long in the horizontal direction.

In an example of the present embodiment, description is made on a case in which a well-known configuration of a convolutional neural network is used as a basis and changed to satisfy requirements of the present invention, thereby configuring the depth estimator of the present invention. A configuration disclosed in Non Patent Literature 2 is used as the well-known configuration in the following description.

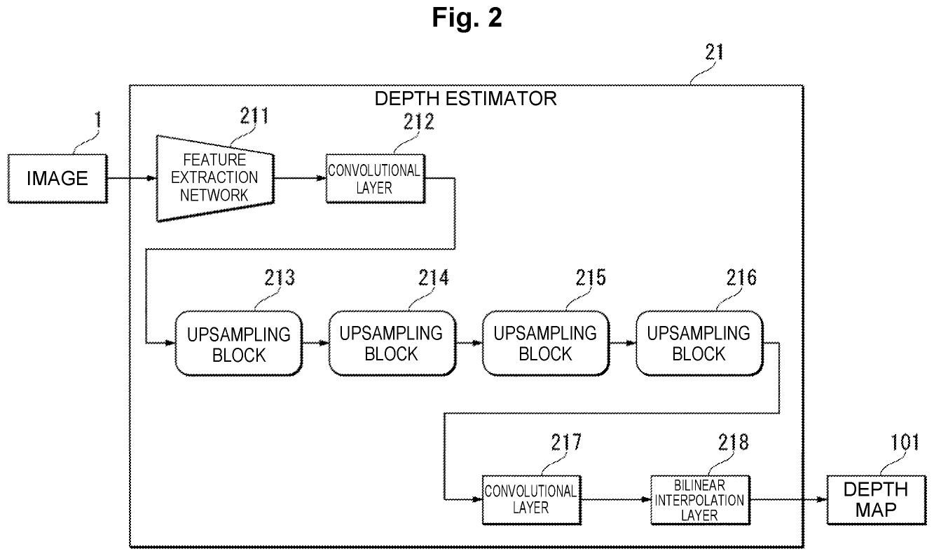

FIG. 2 is a diagram illustrating an exemplary configuration of the depth estimator 21 in the present embodiment.

The depth estimator 21 includes a feature extraction network 211, a convolutional layer 212, four upsampling blocks 213 to 216, a convolutional layer 217, and a bilinear interpolation layer 218. The depth estimator 21 receives an image 1 as an input and outputs a depth map 101.

The feature extraction network 211 is a convolutional neural network having a configuration same as that of a residual network (ResNet) disclosed in Non Patent Literature 3. The feature extraction network 211 outputs a feature map having the format of an order 3 tensor.

The convolutional layer 212 provides a two-dimensional convolution operation to the input feature map, and outputs the feature map provided with the two-dimensional convolution operation to the upsampling block 213.

The upsampling blocks 213 to 216 have identical configurations. The upsampling block 213 upsamples the feature map provided with the two-dimensional convolution operation. Similarly, the upsampling blocks 214 to 216 upsample the input feature map. A channel number is halved and resolutions H and W are each doubled through one upsampling. Thus, the channel number becomes 1/16 times larger and the resolutions become 16 times larger through the four upsampling blocks 213 to 216, and then are output.

The convolutional layer 217 provides a two-dimensional convolution operation to the feature map output from the upsampling block 216 and outputs the feature map provided with the two-dimensional convolution operation to the bilinear interpolation layer 218.

The bilinear interpolation layer 218 converts the input feature map into a desired size (resolution) by applying bilinear interpolation and outputs the depth map 101.

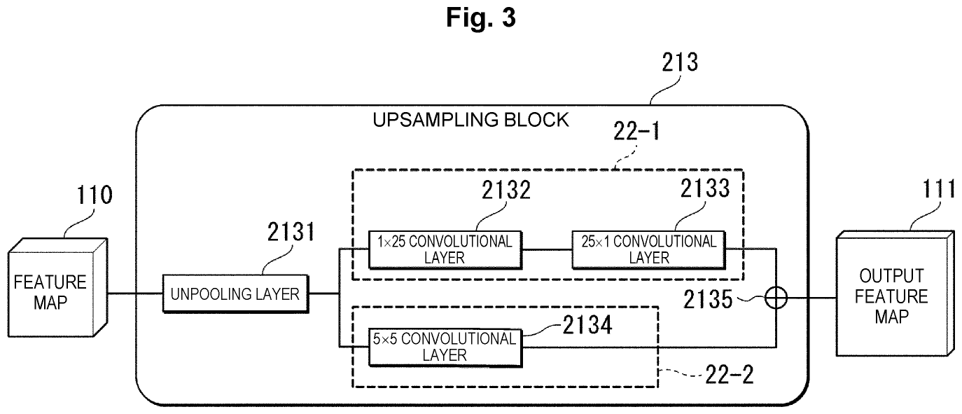

FIG. 3 is a diagram illustrating an exemplary configuration of the upsampling block 213 in the present embodiment. The upsampling blocks 214 to 216 have configurations same as that of the upsampling block 213. In the following description, the size of a feature map of the channel number C, the height H, and the width W is expressed as (C, H, W). A feature map 110 of a size (C, H, W) is input to the upsampling blocks 213 to 216.

The upsampling block 213 includes an unpooling layer 2131, a 1×25 convolutional layer 2132, a 25×1 convolutional layer 2133, a 5×5 convolutional layer 2134, and an addition unit 2135.

The unpooling layer 2131 enlarges the input feature map 110 of a size (C, H, W) two times and outputs a feature map of a size (C, 2H, 2 W) to the 1×25 convolutional layer 2132 and the 5×5 convolutional layer 2134. The feature map output from the unpooling layer 2131 is input to each of a first branch unit 22-1 and a second branch unit 22-2. In FIG. 3, the first branch unit 22-1 includes the 1×25 convolutional layer 2132 and the 25×1 convolutional layer 2133, and the second branch unit 22-2 includes the 5×5 convolutional layer 2134.

The 1×25 convolutional layer 2132 is a two-dimensional convolutional layer including a 1×25 kernel. The 1×25 convolutional layer 2132 is applied to the feature map of a size (C, 2H, 2 W). The 1×25 convolutional layer 2132 outputs a feature map of a size same as that of the input feature map. Specifically, the feature map of a size (C, 2H, 2 W) input to the 1×25 convolutional layer 2132 is output as a feature map of a size (C, 2H, 2 W).

To perform such outputting, the ranges of stride and padding are specified for the 1×25 convolutional layer 2132 as described below. When a kernel has a size of height 1×width 25 as in the 1×25 convolutional layer 2132, the range of stride is specified to (height 1, width 1) and the range of padding is specified to (height 1, width 12). Accordingly, the size of a feature map to be output can be set same as that of the feature map input to the 1×25 convolutional layer 2132.

The 25×1 convolutional layer 2133 is a two-dimensional convolutional layer including a 25×1 kernel. The 25×1 convolutional layer 2133 is applied to the feature map output from the 1×25 convolutional layer 2132. The 25×1 convolutional layer 2133 outputs a feature map of a size same as that of the input feature map. Specifically, the feature map of a size (C, 2H, 2 W) input to the 25×1 convolutional layer 2133 is output as a feature map of a size (C, 2H, 2 W).

To perform such outputting, the ranges of stride and padding are specified for the 25×1 convolutional layer 2133 as described below. When a kernel has a size of height 25×width 1 as in the 25×1 convolutional layer 2133, the range of stride is specified to (height 1, width 1) and the range of padding is specified to (height 12, width 1). Accordingly, the size of a feature map to be output can be set same as that of the feature map input to the 25×1 convolutional layer 2133.

As described above, in the upsampling block 213 in the present embodiment, the first convolutional layer (for example, the 1×25 convolutional layer 2132) among sequential convolutional layers includes a kernel of a longer horizontal length than the other length, and the second convolutional layer (for example, the 25×1 convolutional layer 2133) has the shape of the transpose of the 1×25 convolutional layer 2132.

The example illustrated in FIG. 3 is an example of the upsampling block in the present embodiment, and in the upsampling block in the present embodiment, the first convolutional layer (for example, the 1×25 convolutional layer 2132) may include a kernel of a longer vertical length than the other length, and the second convolutional layer (for example, the 25×1 convolutional layer 2133) may have the shape of the transpose of the 1×25 convolutional layer 2132.

The 5×5 convolutional layer 2134 is a two-dimensional convolutional layer including a 5×5 kernel. The 5×5 convolutional layer 2134 is applied to the feature map of a size (C, 2H, 2 W) and outputs a feature map of a size (C/2, 2H, 2 W) to the addition unit 2135.

The addition unit 2135 sums the feature maps output from the first branch unit 22-1 and the second branch unit 22-2 and outputs a definitive feature map 111.

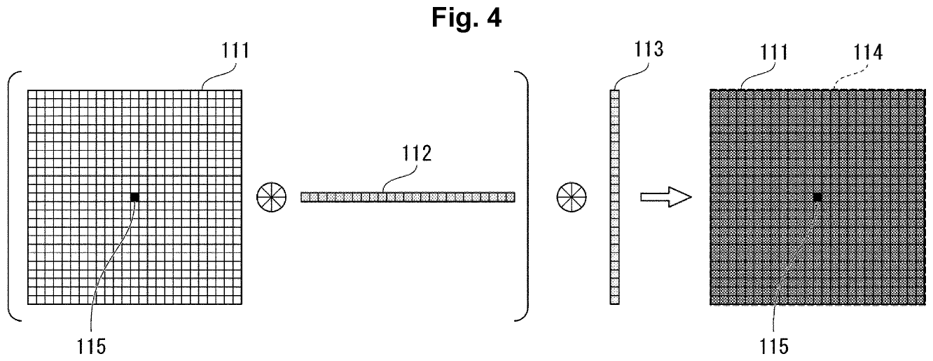

FIG. 4 is a diagram illustrating the range of pixels referred to by the two convolutional kernels of the first branch unit 22-1 when the upsampling block has the configuration illustrated in FIG. 3. In FIG. 4, reference sign 111 denotes the feature map input to the 1×25 convolutional layer 2132, reference sign 112 denotes the 1×25 kernel included in the 1×25 convolutional layer 2132, reference sign 113 denotes the 25×1 kernel included in the 25×1 convolutional layer 2133, and reference sign 114 denotes the range of pixels of the feature map 111 referred to by the 1×25 convolutional layer 2132 and the 25×1 convolutional layer 2133.

As illustrated in FIG. 4, when the 1×25 convolutional kernel 112 and the 25×1 convolutional kernel are used, the pixel value of a black pixel 115 positioned at the center of the feature map 111 is calculated based on pixel values in the range (range denoted by reference sign 114) of 25×25 pixels around the black pixel 115. Thus, the upsampling block 213 in the present embodiment can determine the value of each pixel value based on information in a larger range.

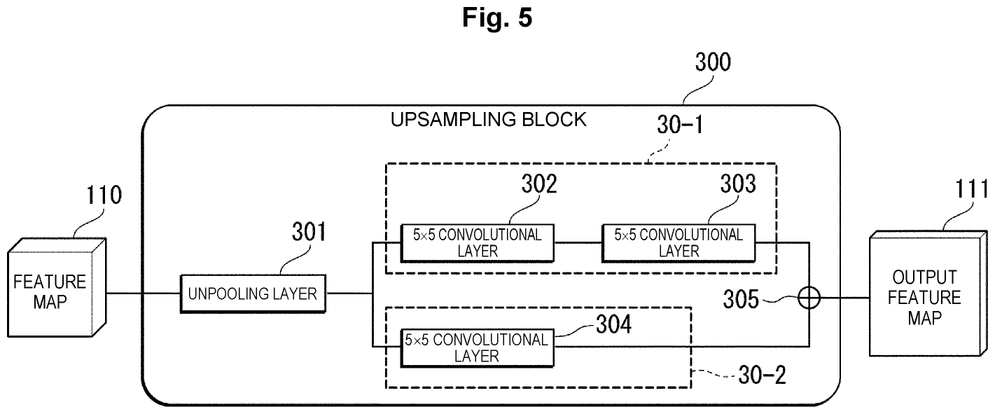

For this comparison, an upsampling block 300 disclosed in Non Patent Literature 2 as a conventional technology will be described below. FIG. 5 is a diagram illustrating the configuration of the upsampling block 300 disclosed in Non Patent Literature 2. More precisely, a 3×3 convolutional layer is used as a convolutional layer denoted by reference sign 303 in the upsampling block of Non Patent Literature 2, but in the following description, is replaced with a 5×5 convolutional layer for sake of simplicity.

The feature map 110 of a size (C, H, W) is input to the upsampling block 300.

The upsampling block 300 includes an unpooling layer 301 and 5×5 convolutional layers 302 to 304.

The unpooling layer 301 enlarges the input feature map 110 of a size (C, H, W) two times and outputs a resulting feature map of a size (C, 2H, 2 W) to the 5×5 convolutional layers 302 and 304. The feature map output from the unpooling layer 301 is input to each of a first branch unit 30-1 and a second branch unit 30-2. In FIG. 5, the first branch unit 30-1 includes the 5×5 convolutional layer 302 and the 5×5 convolutional layer 303, and the second branch unit 30-2 includes the 5×5 convolutional layer 304.

In the first branch unit 30-1, the 5×5 convolutional layer 302 is first applied to the feature map of a size (C, 2H, 2 W) and a resulting feature map of a size (C/2, 2H, 2 W) is output, and in addition, the 5×5 convolutional layer 302 is applied to the output feature map and a resulting feature map of the same size is output.

In the second branch unit 30-2, the 5×5 convolutional layer 304 is applied alone to the feature map of a size (C, 2H, 2 W), and a resulting feature map of a size (C/2, 2H, 2 W) is output. The feature maps output from the first branch unit 30-1 and the second branch unit 30-2 both have a size of (C/2, 2H, 2 W). Lastly, the feature maps of a size (C/2, 2H, 2 W) output from the first branch unit 30-1 and the second branch unit 30-2, respectively, are summed by an addition unit 305, and a definitive output feature map 111 is output.

The configuration of the upsampling block disclosed in Non Patent Literature 2 is described above.

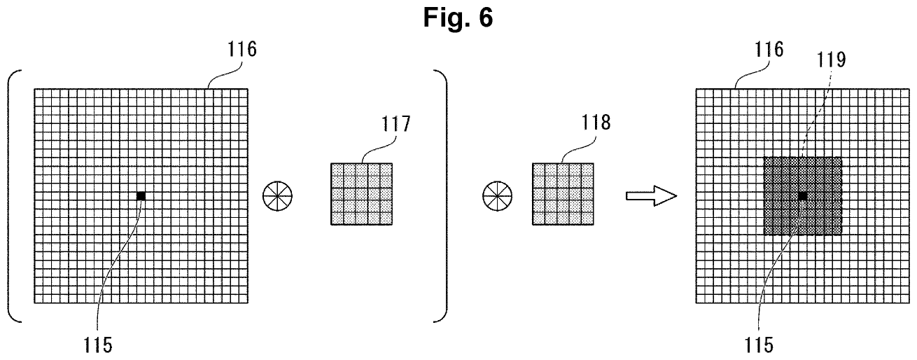

FIG. 6 is a diagram illustrating the range of pixels referred to by two convolutional kernels of the first branch unit 30-1 when an upsampling block has the configuration illustrated in FIG. 5. In FIG. 6, reference sign 116 denotes a feature map input to the 5×5 convolutional layer 302, reference sign 117 denotes the 5×5 kernel included in the 5×5 convolutional layer 302, reference sign 118 denotes the 5×5 kernel included in the 5×5 convolutional layer 303, and reference sign 119 denotes the range of pixels of a feature map 116 referred to by the 5×5 convolutional layer 302 and the 5×5 convolutional layer 303.

As illustrated in FIG. 6, when two 5×5 convolutional kernels are used as in Non Patent Literature 2, the pixel value of a black pixel 115 positioned at the center of the feature map 116 is calculated based on pixel values in the range (range denoted by reference sign 119) of 9×9 pixels around the black pixel 115.

According to the above-described contents, the number of parameters of each kernel is 25 in each of the case of FIGS. 4 and 6, and the number of calculations necessary for a convolution operation is equal as well. Moreover, the upsampling block 213 in the present embodiment can refer to information in a larger range with a calculation amount equivalent to that in the case of Non Patent Literature 2 as a conventional technology.

<Training Processing>

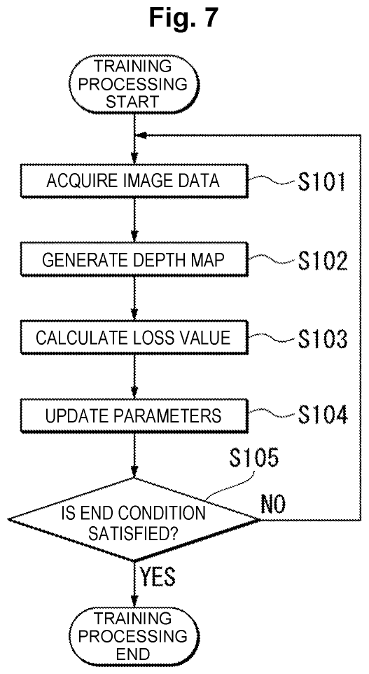

FIG. 7 is a flowchart illustrating the process of training processing performed by the depth estimation device 100 in the present embodiment. The training processing is processing that needs to be performed at least once before depth estimation processing is performed. More specifically, the training processing is processing for appropriately determining weights of the neural network as parameters of the depth estimator 21 based on training data.

To execute the training processing in the present embodiment, training image data needs to be prepared in advance. For production of the training image data, various kinds of well-known means are available for obtaining a correct-answer depth map corresponding to an input image, and any means may be used. For example, as disclosed in Non Patent Literature 1 and Non Patent Literature 3, a depth map acquired by using a commercially available depth camera may be used, or a depth map may be obtained based on depth information measured by using a stereo camera or a plurality of images.

Hereinafter, image data as an i-th (i is an integer equal to or larger than one) input is denoted by Iᵢ, a corresponding correct-answer depth map is denoted by Tᵢ, and a depth map estimated by the depth estimator 21 is denoted by Dᵢ=f(Iᵢ). In this notation, f represents the depth estimator 21. Pixel values of the image data Iᵢ, the correct-answer depth map Tᵢ, and the depth map Dᵢ at coordinates (x,y) are represented by Iᵢ(x,y), Tᵢ(x,y), and Dᵢ(x,y), respectively. A loss function is denoted by lᵢ. Initialization to i=1 is performed in advance.

First at step S101, the image data acquisition unit 11 acquires the image data Iᵢ. The image data acquisition unit 11 outputs the acquired image data Iᵢ to the depth estimation unit 12.

At step S102, the depth estimation unit 12 inputs the image data Iᵢ to the depth estimator 21 to generate the depth map Dᵢ=f(Iᵢ). The depth estimation unit 12 outputs the generated depth map Dᵢ=f(Iᵢ) to the training unit 13.

At step S103, the training unit 13 calculates a loss value lᵢ(Dᵢ,Tᵢ) based on the depth map Dᵢ and the correct-answer depth map Tᵢ input from outside.

At step S104, the training unit 13 updates the parameters of the depth estimator 21 to decrease the loss value lᵢ(Dᵢ,Tᵢ). Then, the training unit 13 records the updated parameters in the storage unit 20.

At step S105, the control unit 10 determines whether a predetermined end condition is satisfied. When the predetermined end condition is satisfied (YES at step S105), the depth estimation device 100 ends the training processing. When the predetermined end condition is not satisfied (NO at step S105), the depth estimation device 100 increments i (i←i+1) and returns to the processing at step S101.

The end condition may be such that, for example, “the training processing is ended after a predetermined number of times (for example, 100 times) of repetitions” or “the training processing is ended after the amount of decrease of the loss value stays in a certain range for a certain number of times of repetitions”.

As described above, the training unit 13 updates the parameters of the depth estimator 21 based on the loss value lᵢ(Dᵢ,Tᵢ) calculated from error between the generated training depth map Dᵢ and the correct-answer depth map Tᵢ.

An example in the present embodiment will be described below for detail processing of the processing at each of the above-described steps S102, S103, and S104.

[Step S102: Depth Estimation Processing]

The depth estimator 21 can be an optional function capable of outputting the depth map Dᵢ based on the image data Iᵢ as input, but in the present embodiment, is a convolutional neural network constituted by one or more convolution operations. The configuration of the neural network may be an optional configuration that can achieve the input-output relation as described above.

[Step S103: Loss Function Calculation Processing]

In this processing, the training unit 13 calculates the loss value based on the correct-answer depth map Tᵢ corresponding to the input image data Iᵢ and on the depth map Dᵢ estimated by the depth estimator 21. Through step S102, the depth map Dᵢ estimated by the depth estimator 21 is obtained for the training image data Iᵢ. The depth map Dᵢ has to be an estimation result of the correct-answer depth map Tᵢ. Thus, it is a preferable basic procedure to design a loss function that calculates the loss value to be smaller as the depth map Dᵢ is closer to the correct-answer depth map Tᵢ and to be larger as the depth map Dᵢ is farther away from the correct-answer depth map Tᵢ.

In a simplest way, as disclosed in Non Patent Literature 3, the loss function may be the sum of the distance between corresponding pixel values in the depth map Dᵢ and the correct-answer depth map Tᵢ. The distance between pixel values may be, for example, L1 distance, and in this case, the loss function can be determined as in Expression (1) below.

$$\begin{matrix}[ Math . 1 ] & \\ {l}_{L 1} ( {T}_{i} , {D}_{i} ) = \frac{1}{N} {\sum }_{i = 1}^{N} {\sum }_{y ∈ {Y}_{i}} {\sum }_{x ∈ {X}_{i}} \vert {e}_{i} ( x , y ) \vert & ( 1 )\end{matrix}$$

In Expression (1), Xᵢ represents the domain of x, and Yᵢ represents the domain of y. A pair of x and y indicates the position of a pixel on each depth map. The value N represents the number of pairs of a depth map as training data and a correct-answer depth map or represents a constant equal to or smaller than the number of pairs. The value eᵢ(x,y) is given by eᵢ(x,y)=Tᵢ(x,y)−Dᵢ(x,y) and represents error between pixels in the training depth map Dᵢ and the correct-answer depth map Tᵢ.

The loss function provides a smaller value as each pair of corresponding pixels in the correct-answer depth map Tᵢ and the depth map Dᵢ are uniformly closer to each other and provides zero in a case of Tᵢ=Dᵢ. Thus, the depth estimator 21 capable of outputting the more accurate depth map Dᵢ can be obtained by updating the parameters of the depth estimator 21 so that the value decreases for various maps Tᵢ and Dᵢ.

The loss function may be a loss function indicated by Expression (2) below like a method disclosed in Non Patent Literature 1.

$$\begin{matrix}[ Math . 2 ] & \\ {l}_{BerHu} ( {T}_{i} , {D}_{i} ) = \frac{1}{N} {\sum }_{i = 1}^{N} {\sum }_{y ∈ {Y}_{i}} {\sum }_{x ∈ {X}_{i}} {d}_{i} ( x , y ) & ( 2 )\end{matrix}$$

$${d}_{i} ( x , y ) = \{ \begin{matrix}\vert {e}_{i} ( x , y ) \vert & if \vert {e}_{i} ( x , y ) \vert \leq c \\ \frac{{( {e}_{i} ( x , y ) )}^{2} + {c}^{2}}{2 c} & ohterwise\end{matrix}$$

The loss function of Expression (2) above is a function that is linear where the depth estimation error is small and that is a quadratic function where the depth estimation error is large.

However, existing loss functions as indicated by Expression (1) above or Expression (2) above have problems. The distance is potentially physically long in a region corresponding to pixels for which the error |eᵢ(x,y)| is large in a depth map. Alternatively, a region corresponding to pixels for which the error |eᵢ(x,y)| is large in a depth map is potentially a part having an extremely complicate depth structure.

Such a place in a depth map is often a region having uncertainty. Accordingly, such a place in a depth map is often not a region in which the depth can be accurately estimated by the depth estimator 21. Thus, training with a focus on a region including pixels for which the error |eᵢ(x,y)| is large in a depth map does not necessarily improve the accuracy of the depth estimator 21.

The loss function of Expression (1) above constantly takes the same loss value irrespective of the magnitude of the error |eᵢ(x,y)|. However, the loss function of Expression (2) above is designed to take a larger loss value as the error |eᵢ(x,y)| is larger. Accordingly, training of the depth estimator 21 by using the loss function indicated by Expression (1) above or Expression (2) above has limitations for improvement of the accuracy of estimation by the depth estimator 21.

Thus, the training unit 13 in the present embodiment uses a loss function indicated by Expression (3) below.

$$\begin{matrix}[ Math . 3 ] & \\ {l}_{i} ( {T}_{i} , {D}_{i} ) = \frac{1}{N} {\sum }_{i = 1}^{N} {\sum }_{y ∈ {Y}_{i}} {\sum }_{x ∈ {X}_{i}} {d}_{i} ( x , y ) & ( 3 )\end{matrix}$$

$${d}_{i} ( x , y ) = \{ \begin{matrix}\vert {e}_{i} ( x , y ) \vert & if \vert {e}_{i} ( x , y ) \vert \leq c \\ \sqrt{2 c \vert {e}_{i} ( x , y ) \vert - {c}^{2}} & ohterwise\end{matrix}$$

When the error |eᵢ(x,y)| is equal to or smaller than a threshold value c, the loss value of the loss function linearly increases as the absolute value |eᵢ(x,y)| of the error increases. When the error |eᵢ(x,y)| is larger than the threshold value c, the loss value of the loss function changes with the root of the error |eᵢ(x,y)|.

The loss function of Expression (3) above is same as another loss function (for example, the loss function of Expression (1) or (2) above) in that the loss function at a pixel for which the error |eᵢ(x,y)| is equal to or smaller than the threshold value c linearly increases as |eᵢ(x,y)| increases.

However, the loss function of Expression (3) above at a pixel for which the error |eᵢ(x,y)| is larger than the threshold value c is a root function of increase of |eᵢ(x,y)|. Thus, in the present embodiment, the loss value for a pixel having uncertainty is evaluated to be small and is underestimated as described above. This can improve the robustness and accuracy of estimation by the depth estimator 21.

Accordingly, the training unit 13 calculates the loss value lᵢ from error between the training depth map Dᵢ and the correct-answer depth map Tᵢ by using Expression (3) above and trains the depth estimator 21 so that the loss value lᵢ decreases.

[Step S104: Parameter Update]

The loss function of Expression (3) above can be differentiated piecewise with respect to a parameter w of the depth estimator 21. Thus, the parameter w of the depth estimator 21 can be updated by a gradient method. For example, the depth estimation unit 12 updates the parameter w based on Expression (4) below per step when training the parameter w of the depth estimator 21 based on the stochastic gradient descent method. Note that a is a coefficient set in advance.

$$\begin{matrix}[ Math . 4 ] & \\ w ← w - α \frac{\partial }{\partial w} {l}_{i} & ( 4 )\end{matrix}$$

The differential value of the loss function with respect to the optional parameter w of the depth estimator 21 can be calculated by the error backpropagation method. Note that, when training the parameter w of the depth estimator 21, the training unit 13 may introduce a typical improvement method of the stochastic gradient descent method, such as use of a momentum term or use of weight decay. Alternatively, the training unit 13 may train the parameter w of the depth estimator 21 by using another gradient descent method.

Then, the training unit 13 stores the trained parameter w of the depth estimator 21 in the depth estimator 21. Accordingly, the depth estimator 21 for accurately estimating a depth map is obtained.

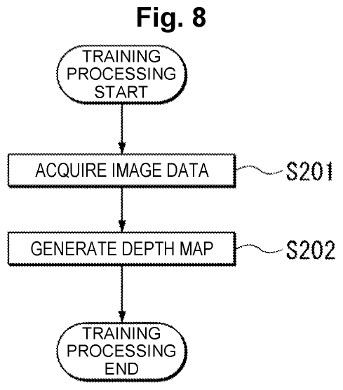

FIG. 8 is a flowchart illustrating the process of the estimation processing performed by the depth estimation device 100 in the present embodiment. It is assumed that the depth estimator 21 trained by the training processing illustrated in FIG. 7 is stored in the storage unit 20 at start of the processing in FIG. 8.

The image data acquisition unit 11 acquires image data (step S201). The image data acquisition unit 11 outputs the acquired image data to the depth estimation unit 12. The depth estimation unit 12 inputs the image data output from the image data acquisition unit 11 to the depth estimator 21 stored in the storage unit 20. Accordingly, the depth estimation unit 12 generates a depth map for the image data (step S202).

With the depth estimation device 100 configured as described above, it is possible to estimate highly accurately the depth. Specifically, the depth estimation device 100 includes an upsampling block in which a first convolutional layer and a second convolutional layer are sequentially provided, the first convolutional layer including a kernel that is long in any one of the vertical and horizontal directions, the second convolutional layer including a kernel that is long in a direction different from that of the first convolutional layer. The depth estimation device 100 sequentially applies the first convolutional layer and the second convolutional layer to a feature map extracted from an input image, thereby calculating information of the depth of a target pixel based on the values of pixels linearly provided in the vertical and horizontal directions, which are useful in depth estimation. Thus, it is possible to highly accurately estimate the depth.

The depth estimation device 100 uses two sequential convolutional layers that do not have equal lengths in each of the vertical and horizontal directions but are each long only in one direction. Accordingly, it is possible to highly accurately estimate the depth while preventing increase in the number of parameters and the amount of calculation. For example, when a square kernel, specifically, a 25×25 kernel is used in preparation for a kernel having a length corresponding to 25 pixels in each of the vertical and horizontal directions, the number of parameters of the kernel and the amount of calculation are 25×25=625 per channel. However, the depth estimation device 100 in the present embodiment uses two sequential kernels having sizes of 1×25 and 25×1. In this case, the number of parameters and the amount of calculation can be reduced to 25+25=50 per channel.

In addition, the range of pixels covered by the two sequential kernels (on an input tensor referred to for calculating an output) is same as that in a case in which a 25×25 square kernel is used. In other words, the depth estimation device 100 can estimate depth information by referring to information of the same range on the input tensor with a smaller number of parameters and a smaller amount of calculation.

Modifications of the depth estimation device 100 will be described below.

In the above-described embodiment, the depth estimation device 100 includes the training unit 13, but the depth estimation device 100 does not necessarily need to include the training unit 13. With this configuration, the training unit 13 is included in an external device different from the depth estimation device 100. The depth estimation device 100 acquires, from the external device, the parameters of the depth estimator 21 trained by the external device, and records the acquired parameters in the storage unit 20.

The above-described configuration of the upsampling blocks 213 to 216 is merely exemplary, and the configuration of the upsampling blocks 213 to 216 may be a first modified configuration or a second modified configuration described below. Detailed description is as follows.

(First Modified Configuration)

A requirement for the depth estimation device 100 in the present embodiment is a configuration in which one of sequential convolutional layers includes a kernel having a longer length in any one of the vertical and horizontal directions than a length in the other direction and the other convolutional layer has the shape of the transpose of the one convolutional layer. This condition is satisfied by a plurality of pairs of convolutional kernels.

Consider a case in which the size of a kernel is limited to an odd number to request maintaining the sizes of input and output feature maps to be identical. In this case, there are four pairs of 25×1 and 1×25, 3×9 and 9×3, 9×3 and 3×9 as well as 1×25 and 25×1 when the number of parameters is substantially equal to 5×5.

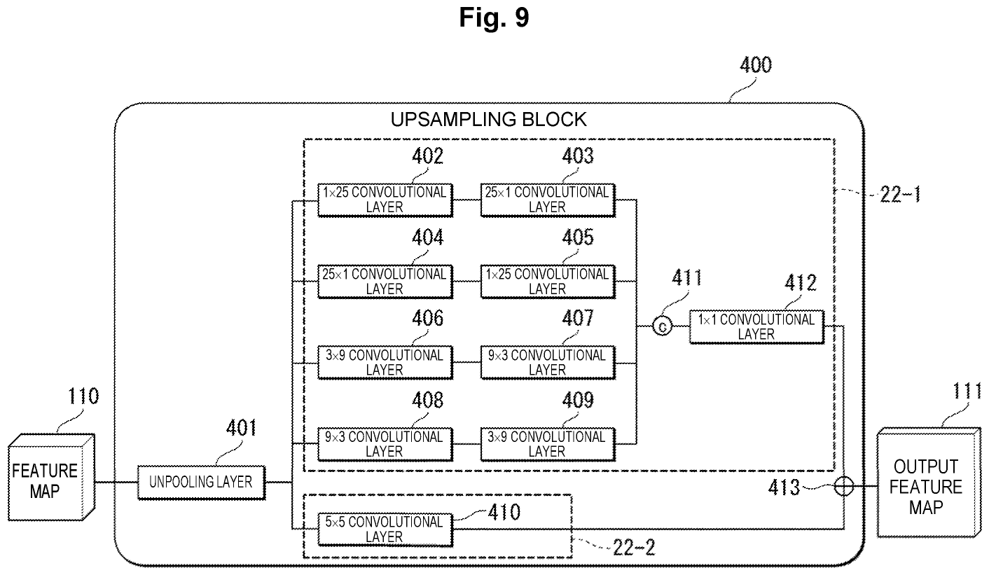

The range of pixels of an input feature map referred to for determining the value of a certain pixel changes when the shape of a kernel is changed. In other words, a range that is focused on to determine the value of each pixel is defined, and thus an upsampling block that focuses on and refers to further various kinds of ranges can be configured by using a plurality of different pairs in combination. FIG. 9 is a diagram illustrating an example of the first modified configuration of an upsampling block. The first modified configuration of an upsampling block is a configuration using all four pairs described above.

An upsampling block 400 includes an unpooling layer 401, a 1×25 convolutional layer 402, a 25×1 convolutional layer 403, a 25×1 convolutional layer 404, a 1×25 convolutional layer 405, a 3×9 convolutional layer 406, a 9×3 convolutional layer 407, a 9×3 convolutional layer 408, a 3×9 convolutional layer 409, a 5×5 convolutional layer 410, a coupling unit 411, a 1×1 convolutional layer 412, and an addition unit 413.

The configuration of the upsampling block 400 is different from the configuration of the upsampling block 213 in that subbranch units constituted by a plurality of pairs of kernels having different shapes are provided in parallel in a first branch unit 22-1. The upsampling block 400 first applies the unpooling layer 401 to the feature map 110 of a size (C, H, W) and outputs a feature map of a size (C, 2H, 2 W) enlarged two times.

In a second branch unit 22-2, similarly to the above-described example, the 5×5 convolutional layer 410 is applied alone to the feature map of a size (C, 2H, 2 W), and a feature map of a size (C/2, 2H, 2 W) is output.

The first branch unit 22-1 includes a first subbranch unit, a second subbranch unit, a third subbranch unit, and a fourth subbranch unit, the coupling unit 411, and the 1×1 convolutional layer 412, the first subbranch unit including the 1×25 convolutional layer 402 and the 25×1 convolutional layer 403, the second subbranch unit including the 25×1 convolutional layer 404 and the 1×25 convolutional layer 405, the third subbranch unit including the 3×9 convolutional layer 406 and the 9×3 convolutional layer 407, the fourth subbranch unit including the 9×3 convolutional layer 408 and the 3×9 convolutional layer 409. In the first branch unit 22-1, the feature map passes through the first subbranch unit, the second subbranch unit, the third subbranch unit, and the fourth subbranch unit.

In each of the first to fourth subbranch units, a first convolutional layer (any of 402, 404, 406, and 408) is applied to the feature map of a size (C, 2H, 2 W), and a feature map of (C/8, 2H, 2 W) is output. In addition, a second convolutional layer (any of 403, 405, 407, and 409) is applied and a feature map of the same size is output.

The feature maps output from the first to fourth subbranch units have a size of (C/8, 2H, 2 W) and are coupled in a channel direction by the coupling unit 411. Accordingly, a feature map of a size (C/2, 2H, 2 W) is obtained. Thereafter, the feature map of a size (C/2, 2H, 2 W) is input to the 1×1 convolutional layer 412. A feature map output from the 1×1 convolutional layer 412 and the feature map of a size (C/2, 2H, 2 W) output from the second branch unit 22-2 are summed by the addition unit 413 to obtain a definitive output feature map 111.

With the above-described configuration, an upsampling block that focuses on and refers to further various kinds of ranges can be configured. In addition, the four subbranch units and the 1×1 convolutional layer 412 are provided in the first branch unit 22-1, but the channel number of each subbranch unit is reduced to ¼. Accordingly, unlike appearance, the number of parameters can be reduced as compared to the cases of FIGS. 3 and 5.

(Second Modified Configuration)

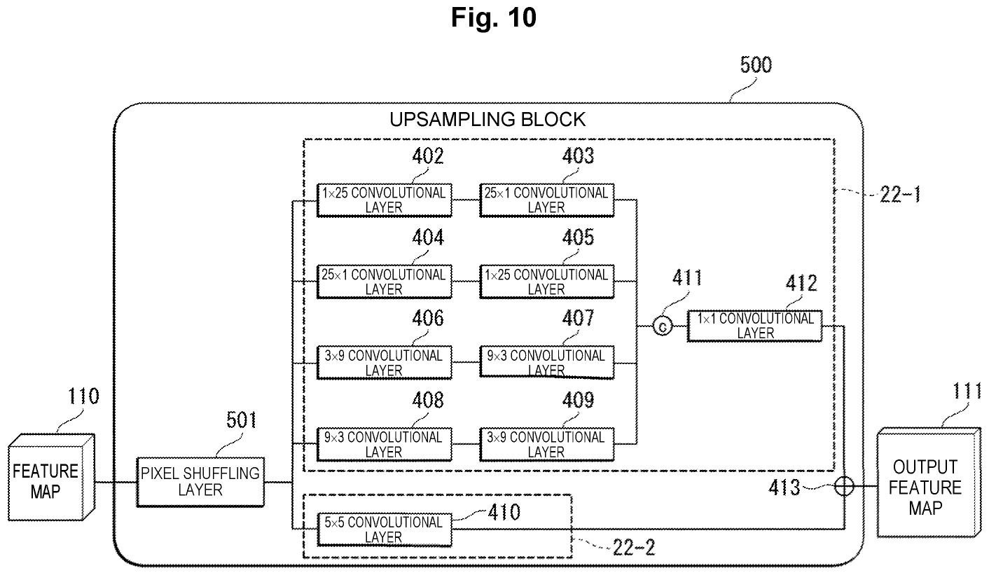

FIG. 10 is a diagram illustrating an example of the second modified configuration of an upsampling block. An upsampling block 500 illustrated in FIG. 10 uses a pixel shuffling layer 501 described in Reference Literature 1 in place of the unpooling layer 401 of the upsampling block 400 illustrated in FIG. 9. Accordingly, the number of parameters can be further largely reduced. (Reference Literature 1: Wenzhe Shi, Jose Caballero, Ferenc Huszar, Johannes Totz, Andrew P. Aitken, Rob Bishop, Daniel Rueckert, and Zehan Wang, “Real-Time Single Image and Video Super-Resolution Using an Efficient Sub-Pixel Convolutional Neural Network”, In Proc. Conference on Computer Vision and Pattern Recognition (CVPR), 2018.)

Any of the configurations includes sequential convolutional layers, one of the sequential convolutional layers including a kernel having a longer length in one of the vertical and horizontal directions than a length in the other direction, the other convolutional layer having the shape of the transpose of the one convolutional layer.

(Experimental Results)

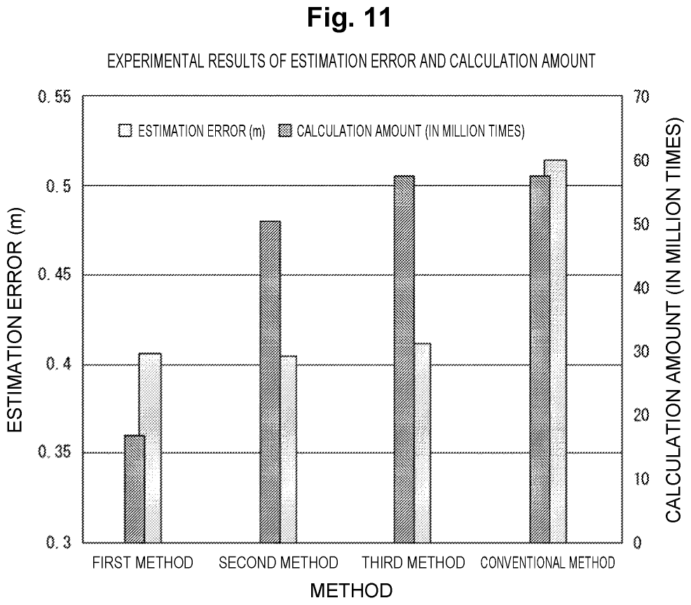

FIG. 11 is a diagram illustrating experimental results obtained by performing depth estimation by using depth estimation methods established by the above-described conventional technology and the technology of the present invention. This experiment was performed by using data obtained by image capturing of an indoor space with a camera equipped with a depth sensor. Training was performed by using training image data including 23,488 pairs of an input image and a correct-answer depth map. Evaluation was performed by using evaluation data including 654 pairs of an image and a correct-answer depth map different from the training image data.

In FIG. 11, the horizontal axis represents method, and the vertical axis represents estimation error. A first method is a method using the upsampling block in FIG. 3. A second method is a method using the upsampling block in FIG. 9. A third method is a method using the upsampling block in FIG. 10. A conventional method is a method using the upsampling block in FIG. 5.

As clearly understood from FIG. 11, the present technology can perform extremely highly accurate recognition as compared to that of the conventional technology. In addition, as clearly understood from comparison in the amount of calculation, a significantly smaller amount of calculation as compared to that of the conventional method can be achieved as well.

The embodiment of the present invention is described above in detail with reference to the accompanying drawings, but specific configurations are not limited to the embodiment but include designing and the like within the scope of the present invention.

### INDUSTRIAL APPLICABILITY

The present invention is applicable to depth information estimation technologies.

### REFERENCE SIGNS LIST

100 depth estimation device
10 control unit
11 image data acquisition unit
12 depth estimation unit
13 training unit
20 storage unit
21 depth estimator
211 feature extraction network
212, 217 convolutional layer
213 to 216 upsampling block
218 bilinear interpolation layer
401 unpooling layer
402 1×25 convolutional layer
403 25×1 convolutional layer
404 25×1 convolutional layer
405 1×25 convolutional layer
406 3×9 convolutional layer
407 9×3 convolutional layer
408 9×3 convolutional layer
409 3×9 convolutional layer
410 5×5 convolutional layer
411 coupling unit
412 1×1 convolutional layer
413 addition unit
501 pixel shuffling layer
2131 unpooling layer
2132 1×25 convolutional layer
2133 25×1 convolutional layer
2134 5×5 convolutional layer

1. A depth estimation method using a depth estimator trained to output a depth map of a depth provided to each pixel of an input image, wherein
the depth estimator includes a pair of a first convolutional layer and a second convolutional layer coupled to each other and configured to, when having received, as input, a feature map obtained by applying predetermined conversion to the input image, apply a two-dimensional convolution operation to the feature map and output the feature map to which the two-dimensional convolution operation is applied,
the first convolutional layer is a convolutional layer including a first kernel of a shape having lengths in a first direction and a second direction, the first direction being one of a vertical direction and a horizontal direction, the second direction being different from the first direction, the length in the second direction being longer than the length in the first direction, and
the second convolutional layer is a convolutional layer including a second kernel of a shape having lengths in the first and second directions, the length in the first direction being longer than the length in the second direction.

2. The depth estimation method according to claim 1, wherein the depth estimator
includes two or more pairs of the first convolutional layer and the second convolutional layer coupled to each other, and
couples the feature maps output from the two or more pairs,
respectively, and outputs the coupled feature maps.

3. The depth estimation method according to claim 1, wherein the second convolutional layer is a convolutional layer including a second kernel having the shape of the transpose of the first convolutional layer.

4. A depth estimation device comprising a depth estimator trained to output a depth map of a depth provided to each pixel of an input image, wherein
the depth estimator includes a pair of a first convolutional layer and a second convolutional layer coupled to each other and configured to, when having received, as input, a feature map obtained by applying predetermined conversion to the input image, apply a two-dimensional convolution operation to the feature map and output the feature map to which the two-dimensional convolution operation is applied,
the first convolutional layer is a convolutional layer including a first kernel of a shape having a length in a first direction as one of a vertical direction and a horizontal direction and a length in a second direction different from the first direction, the length in the second direction being longer than the length in the first direction, and
the second convolutional layer is a convolutional layer including a second kernel of a shape having lengths in the first and second directions, the length in the first direction being longer than the length in the second direction.

5. A non-transitory computer-readable medium having computer-executable instructions that, upon execution of the instructions by a processor of a computer, cause the computer to function as the depth estimation method according to claim 1.
